(19) United States
(12) Patent Application Publication
(10) Pub. No.: US 2023/0230423 A1
(43) Pub. Date: Jul. 20, 2023

(54) PHYSICAL AND VIRTUAL IDENTITY ASSOCIATION

(71) Applicant: GM Global Technology Operations LLC, Detroit, MI (US)

(72) Inventors: Bo Yu, Troy, MI (US); Ashok Yendluri, Farmington, MI (US); Vivek Vijaya Kumar, Shelby Township, MI (US); Guangyu Jeff Zou, Warren, MI (US); Kamran Ali, Troy, MI (US)

(21) Appl. No.: 17/579,821

(22) Filed: Jan. 20, 2022

(51) Int. Cl. G07C 5/00; B60W 40/105; B60W 40/114

(52) U.S. Cl. CPC G07C 5/008; B60W 40/105; B60W 40/114; B60W 2554/4049; B60W 2420/42; B60W 2552/53

(57) ABSTRACT

A system for associating a physical identity and a virtual identity of a target vehicle includes a data processor, including a wireless communication module, positioned within an ego vehicle, and a plurality of perception sensors, positioned within the ego vehicle and adapted to collect data related to a physical identity of the target vehicle and to communicate the data related to the physical identity of the target vehicle to the data processor via a communication bus, the data processor adapted to receive, via a wireless communication channel, data related to a virtual identity of the target vehicle and to associate the physical identity of the target vehicle with the virtual identity of the target vehicle.

### INTRODUCTION

The present disclosure relates to a system for associating a physical identity of a target vehicle that is detected by perception sensors within an ego vehicle to a virtual identity of the target vehicle that is received via wireless communication between the ego vehicle and the target vehicle.

In current systems, an ego vehicle using wireless vehicle to vehicle or vehicle to infrastructure communication channels receives information transmitted from a target vehicle that includes identification information about the target vehicle to allow the ego vehicle to identify the target vehicle. This information provides a virtual identity of the target vehicle. This allows the ego vehicle to locate the position of the target vehicle relative to the ego vehicle so the ego vehicle can take actions such as collaborative maneuvering and positioning and infrastructure-assisted coordination.

In addition, an ego vehicle will use perceptions sensors, such as lidar, radar and cameras, positioned within the ego vehicle to identify objects, such as target vehicles that are in proximity to the ego vehicle. This provides a physical identity of detected target vehicles. Often, the perception sensors of the ego vehicle may detect multiple target vehicles. Current systems generally trust the virtual identity information received, without confirming that the virtual identity information received is correlated to the correct physical identity information. In other words, current systems do not verify that information transmitted wirelessly corresponds to the correct one of multiple target vehicles physically identified by the ego vehicle. Thus, while current systems achieve their intended purpose, there is a need for a new and improved system and method for associating a physical identity of a target vehicle that is detected by perception sensors within an ego vehicle to a virtual identity of the target vehicle that is received via wireless communication between the ego vehicle and the target vehicle.

### SUMMARY

According to several aspects of the present disclosure, a method of associating a physical identity and a virtual identity of a target vehicle, includes collecting, with a plurality of perception sensors, data related to a physical identity of the target vehicle and communicating data related to the physical identity of the target vehicle, via a communication bus, to a data processor, collecting, with the data processor, via a wireless communication channel, data related to a virtual identity of the target vehicle, and associating, with the data processor, the physical identity of the target vehicle with the virtual identity of the target vehicle.

According to another aspect, the associating, with the data processor, the physical identity of the target vehicle with the virtual identity of the target vehicle further includes leveraging, with the data processor, a Bayesian Interference Model and estimating, with the data processor, a probability that data related to the physical identity and the data related to the virtual identity are for the same target vehicle.

According to another aspect, the associating, with the data processor, the physical identity of the target vehicle with the virtual identity of the target vehicle further includes using the data related to the physical identity of the target vehicle to determine, with the data processor, a relative position of the target vehicle, and to estimate, with the data processor, a real-time status of the target vehicle.

According to another aspect, the data related to the physical identity of the target vehicle includes global satellite positioning coordinates, speed, acceleration, yaw and heading, and the data related to the virtual identity of the target vehicle includes global satellite positioning coordinates, speed, acceleration, yaw and heading.

According to another aspect, computer vision features created for each model of all vehicles are stored on a cloud-based vehicle profile database, and the data related to the virtual identity of the target vehicle includes model information transmitted by the target vehicle, the method including using model information received from the target vehicle and receiving, with the data processor, corresponding vehicle profile data from the cloud based vehicle profile database.

According to another aspect, the model information transmitted by the target vehicle includes brand, model, year and color.

According to another aspect, the cloud-based vehicle profile database is a deep neural network.

According to another aspect, the data related to the virtual identity of the target vehicle includes data collected by perception sensors on the target vehicle related to the surroundings of the target vehicle.

According to another aspect, the data related to the virtual identity of the target vehicle includes observed lane lines, surrounding vehicles, vulnerable road users (VRUs), street signs, traffic lights and structures.

According to another aspect, the data related to the virtual identity of the target vehicle further includes computer vision features for the target vehicle that are stored on a cloud-based vehicle profile database.

According to several aspects of the present disclosure, a system for associating a physical identity and a virtual identity of a target vehicle includes a data processor, including a wireless communication module, positioned within an ego vehicle, and a plurality of perception sensors, positioned within the ego vehicle and adapted to collect data related to a physical identity of the target vehicle and to communicate the data related to the physical identity of the target vehicle to the data processor via a communication bus, the data processor adapted to receive, via a wireless communication channel, data related to a virtual identity of the target vehicle and to associate the physical identity of the target vehicle with the virtual identity of the target vehicle.

According to another aspect, when associating the physical identity of the target vehicle with the virtual identity of the target vehicle, the data processor is further adapted to leverage a Bayesian Interference Model and estimate a probability that the data related to the physical identity and the data related to the virtual identity are for the same target vehicle.

According to another aspect, when associating the physical identity of the target vehicle with the virtual identity of the target vehicle, the data processor is further adapted to use the data related to the physical identity of the target vehicle to determine a relative position of the target vehicle, and to estimate a real-time status of the target vehicle.

According to another aspect, the data related to the physical identity of the target vehicle includes global satellite positioning coordinates, speed, acceleration, yaw and heading, and the data related to the virtual identity of the target vehicle includes global satellite positioning coordinates, speed, acceleration, yaw and heading.

According to another aspect, the system further includes a cloud-based vehicle profile database that includes computer vision features created for each model of all vehicles, and the data related to the virtual identity of the target vehicle includes model information transmitted by the target vehicle, the data processor further adapted to use model information received from the target vehicle and to receive corresponding vehicle profile data from the cloud-based vehicle profile database.

According to another aspect, the model information transmitted by the target vehicle includes brand, model, year and color.

According to another aspect, the cloud-based vehicle profile database is a deep neural network.

According to another aspect, the data related to the virtual identity of the target vehicle includes data collected by perception sensors on the target vehicle related to the surroundings of the target vehicle, including observed lane lines, surrounding vehicles, vulnerable road users (VRUs), street signs, traffic lights and structures.

According to another aspect, the system further includes a cloud-based vehicle profile database that includes computer vision features created for each model of all vehicles, and the data related to the virtual identity of the target vehicle further includes computer vision features for the target vehicle.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

The drawings described herein are for illustration purposes only and are not intended to limit the scope of the present disclosure in any way.

FIG. 1 is a schematic diagram of a system for associating a physical identity and a virtual identity of a target vehicle in accordance with an exemplary embodiment of the present disclosure;

FIG. 2 is a schematic illustration of an application of the system of the present disclosure wherein an ego vehicle is associating a physical and virtual identity for each of two target vehicles;

FIG. 3, is a schematic diagram illustrating the relationship of the identified physical identity, the received virtual identity, and the actual position of a target vehicle relative to an ego vehicle;

FIG. 4 is a probability distribution graph of the physical identity, the virtual identity and the actual position of a target vehicle;

FIG. 5 is a probability distribution graph of a feature distance for a target vehicle;

FIG. 6 is a schematic illustration of an application of the system of the present disclosure wherein an ego vehicle is leveraging a target vehicle's perception data;

FIG. 7, is a schematic diagram illustrating the relationship of the identified physical identity and received virtual identity for each of two target vehicles;

FIG. 8 is a schematic illustration of an application of the system of the present disclosure wherein an ego vehicle utilizes the system for collaborative lane changing;

FIG. 9 is a schematic illustration of an application of the system of the present disclosure wherein the system is utilized for infrastructure-coordinated maneuvers and infrastructure-assisted precise positioning;

FIG. 10 is a schematic illustration of an application of the system of the present disclosure wherein the system is utilized for sharing of physical and virtual identity association information between vehicles;

FIG. 11 is a schematic diagram illustrating the relationship of the identified physical identity and received virtual identity for each of two target vehicles, wherein one of the target vehicle is sharing it's perception information with the ego vehicle; and

FIG. 12 is a schematic flow chart illustrating a method of using a system for associating a physical identity and a virtual identity of a target vehicle.

The figures are not necessarily to scale and some features may be exaggerated or minimized, such as to show details of particular components. In some instances, well-known components, systems, materials or methods have not been described in detail in order to avoid obscuring the present disclosure. Therefore, specific structural and functional details disclosed herein are not to be interpreted as limiting, but merely as a basis for the claims and as a representative basis for teaching one skilled in the art to variously employ the present disclosure.

### DETAILED DESCRIPTION

The following description is merely exemplary in nature and is not intended to limit the present disclosure, application, or uses. Furthermore, there is no intention to be bound by any expressed or implied theory presented in the preceding technical field, background, brief summary or the following detailed description. It should be understood that throughout the drawings, corresponding reference numerals indicate like or corresponding parts and features. As used herein, the term module refers to any hardware, software, firmware, electronic control component, processing logic, and/or processor device, individually or in any combination, including without limitation: application specific integrated circuit (ASIC), an electronic circuit, a processor (shared, dedicated, or group) and memory that executes one or more software or firmware programs, a combinational logic circuit, and/or other suitable components that provide the described functionality. Although the figures shown herein depict an example with certain arrangements of elements, additional intervening elements, devices, features, or components may be present in actual embodiments. It should also be understood that the figures are merely illustrative and may not be drawn to scale.

As used herein, the term “vehicle” is not limited to automobiles. While the present technology is described primarily herein in connection with automobiles, the technology is not limited to automobiles. The concepts can be used in a wide variety of applications, such as in connection with aircraft, marine craft, other vehicles, and consumer electronic components.

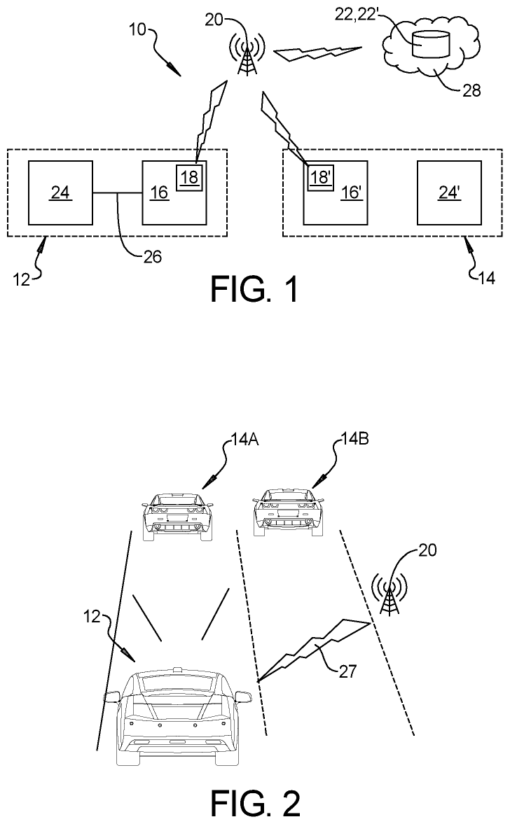

Referring to FIG. 1, a system 10 within an ego vehicle 12 for associating a physical identity and a virtual identity of a target vehicle 14 includes a data processor 16 that includes a wireless communication module 18, positioned within the ego vehicle 12.

The data processor 16 is a non-generalized, electronic control device having a preprogrammed digital computer or processor, memory or non-transitory computer readable medium used to store data such as control logic, software applications, instructions, computer code, data, lookup tables, etc., and a transceiver or input/output ports. Computer readable medium includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device. Computer code includes any type of program code, including source code, object code, and executable code.

The data processor 16 includes a wireless communication module 18 that is adapted to allow wireless communication between the ego vehicle 12 and other vehicles or other external sources. The data processor 16 is adapted to collect information from databases 22 via a wireless data communication network 20 over wireless communication channels such as a WLAN, 4G/LTE or 5G network, or the like. Such databases 22 can be communicated with directly via the internet, or may be cloud-based databases. Information that may be collected by the data processor 16 from such external sources includes, but is not limited to road and highway databases maintained by the department of transportation, a global positioning system, the internet, other vehicles via V2V communication networks, traffic information sources, vehicle-based support systems such as OnStar, etc.

The wireless communication module 18 enables bi-directional communications between the data processor 16 of the ego vehicle 12 and other vehicles, mobile devices and infrastructure for the purpose of triggering important communications and events.

The system 10 further includes a plurality of perception sensors 24, positioned within the ego vehicle 12. The plurality of perception sensors 24 includes sensors adapted to collect data related to a physical identity of the target vehicle 14. Such sensors 24 include, but are not limited to, Radar, Lidar and cameras, that allow the ego vehicle to “see” nearby objects. The plurality of perception sensors 24 communicate the data related to the physical identity of the target vehicle 14 to the data processor 16 via a communication bus 26 within the ego vehicle 12.

The data processor 16 is further adapted to receive, via a wireless communication channel 20, data related to a virtual identity of the target vehicle 14 and to associate the physical identity of the target vehicle 14 with the virtual identity of the target vehicle 14. The target vehicle 14 includes a plurality of perception sensors 24′ located within the target vehicle 14 and a data processor 16′ that is equipped with a wireless communication module 18′. The plurality of perception sensors 24′ communicate with the data processor 16′ via a communication bus 26′ within the target vehicle 14.

The wireless communication module 18′ within the target vehicle 14 allows the target vehicle 14 to transmit data related to a virtual identity of the target vehicle 14 to the ego vehicle 12 via the wireless communication network 20.

Referring to FIG. 2, in an example scenario, the plurality of perception sensors 24 within an ego vehicle 12 detect a first target vehicle 14A and a second target vehicle 14B in proximity to the ego vehicle 12. The ego vehicle 12 also wirelessly receives data related to a virtual identity of the first target vehicle 14A, as indicated at 26. Such virtual identity data may include, but is not limited to information such as an IP address, yin number, plate number, GPS coordinates, etc. However, the first and second target vehicle 14A, 14B may both be of the same model and the same color, making it difficult for the ego vehicle 12 to properly associate the virtual identity information to the correct one of the first and second target vehicles 14A, 14B. It is important that the ego vehicle 12 properly associate the virtual identity to the correct one of the first and second target vehicles 14A, 14B. For the ego vehicle 12 to effectively and safely make decisions on lane changes, speed adjustments and other such maneuvers, it is important that the ego vehicle 12 correctly associate the virtual identity to the correct physical identity, ie. the correct one of the first and second target vehicles 14A, 14B. This way, the ego vehicle 12 will ensure it is communicating with the correct one of the first and second target vehicles 14A, 14B. In addition, the ego vehicle 12 may receive virtual identity data from each of the first and second target vehicles 14A, 14B. Proper association of virtual and physical identities will ensure the ego vehicle 12 can know what virtual data to associate with which one of the first and second target vehicles 14A, 14B.

When associating the physical identity of the target vehicle 14 with the virtual identity of the target vehicle 14, the data processor 16 is further adapted to leverage a Bayesian Inference Model and estimate a probability that the data related to the physical identity and the data related to the virtual identity are for the same target vehicle 14. In other words, the data processor 16 uses a Bayesian Inference Model to match the data received from the target vehicle 14 to the physical observations of the ego vehicle 12.

When leveraging a Bayesian Inference Model, the data processor 16 builds a two-dimensional discrete probability distribution table, such as:

| | V₁ | . . . | Vᵢ | . . . | Vₘ |
|---|---|---|---|---|---|
| Pⱼ | P_{j,1} | . . . | P_{j,i} | . . . | P_{j,m}, |

where Σp_{i,j}=1.

There are m virtual identities (V₁ . . . Vₘ) and n physical identities (P₁ . . . Pₙ). p_{i,j} is the probability that Pⱼ is matched to Vᵢ. For each physical identity, such a state model is created, multiple such state models for all physical identities will form a two-dimensional table.

A Baye's theorem is given by:

$$P ( h \vert D ) = \frac{P ( D \vert h ) * P ( h )}{P ( D )} ,$$

where D represents data and h represents a hypothesis. The calculation is given:

$$P ( {h}_{j , i} \vert D ) = \frac{P ( D \vert {h}_{j , i} ) * P ( {h}_{j , i} )}{P ( D )} ,$$

$$and$$

$$P ( D ) = {\sum }_{j , i} P ( D \vert {h}_{j , i} ) * P ( {h}_{j , i} ) ,$$

where

D represents two sets of sensor observations (physical and virtual);

h_{j,i} represents the hypothesis that Physical j is matched to Virtual i;

P(D|h_{j,i}) is sensor data for a given hypothesis, or the likelihood probability distribution of observing the two sets of observation data given the hypothesis;

P(h_{j,i}) is a prior hypothesis, or the prior probability distribution of the hypothesis (the state definition at t−1). At the beginning,

$$P ( {h}_{j , i} ) = \frac{1}{m} .$$

If there are ten target vehicles identified, initially, each probability would be 10%, then would be updated;

P(D) is the evidence probability of two sets of sensor observations; and

P(h_{j,i}|D) is the posterior hypothesis, or the posterior probability distribution of the hypothesis (the state at t). Use sensor observation data to update the state table (hypothesis), as new data comes, the state table is updated to represent the more accurate likelihood that one physical identity is matched to a virtual identity.

A Bayesian Inference Algorithm is as follows:

Step 1: Collect sensor data from two sources. From local perception sensors (physical), and from a wireless communication channel 20 (virtual).

Step 2: Create or update the two-dimensional state table (create new rows/columns if new identities are detected, delete rows/columns in an identity is no longer present). If a new row is created, the columns in the new row are initialized to

$$P ( {h}_{j , i} ) = \frac{1}{m} .$$

Step 3: Use the state table as the prior probability distribution, P(h_{j,i}).

Step 4: Use the sensor data to calculate P(D|h_{j,i}) and P(D).

Step 5: Update the posterior probability distribution, P(h_{j,i}|D).

Step 6: P(h_{j,i}|D) is used to update the two-dimensional state table.

Step 7: In the state table, find the maximal probability of hypothesis (j,i) as the algorithm's current output, i.e. physical identity i with a probability p_{j,i}.

Step 8: return to Step 1.

In one exemplary embodiment, when associating the physical identity of the target vehicle 14 with the virtual identity of the target vehicle 14, the data processor is further adapted to use the data related to the physical identity of the target vehicle 14 to determine a relative position of the target vehicle 14, and to estimate a real-time status of the target vehicle 14. The data related to the physical identity of the target vehicle 14 includes global satellite positioning coordinates, speed, acceleration, yaw and heading, and the data related to the virtual identity of the target vehicle 14 includes global satellite positioning coordinates, speed, acceleration, yaw and heading.

In this embodiment, the target vehicle 14 transmits only basic safety information, including global satellite positioning coordinates, speed, acceleration, yaw and heading. The ego vehicle 12 uses the plurality of perception sensors 24 to determine one or more target vehicle's relative position and estimate its real-time status, i.e. global satellite positioning coordinates, speed, acceleration, yaw and heading. The ego vehicle 12 receives one or more target vehicle's basic safety information, and the data processor within the ego vehicle 12 runs the Bayesian Inference Algorithm and calculates P(D|h_{j,i}) and P(D).

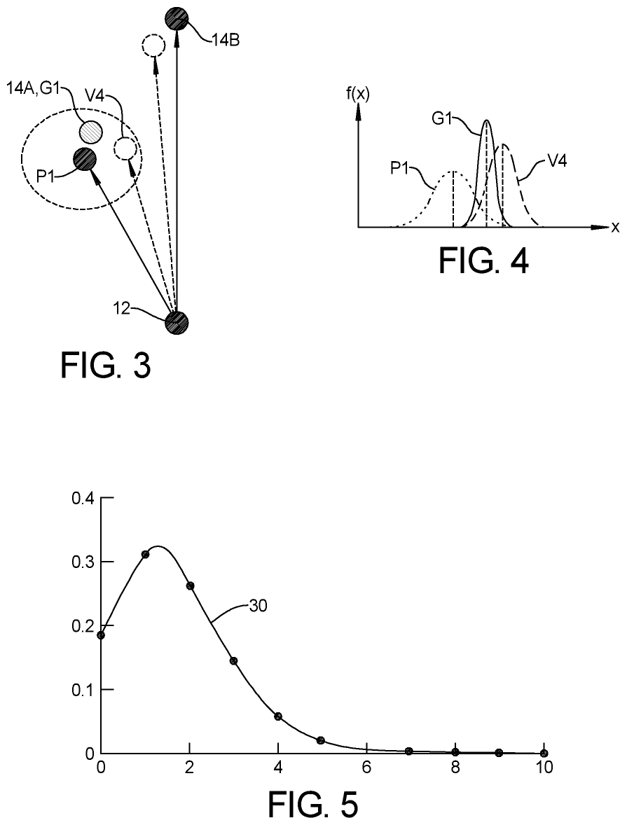

Referring to FIG. 3, an example is shown where an ego vehicle 12 detects with the plurality of perception sensors a first target vehicle 14A and a second target vehicle 14B. For the first target vehicle 14A, the vehicle's position (physical identity), as indicated at P1, is observed by the ego vehicle's perception sensors 24 (camera). The GPS position (virtual identity) of the first target vehicle 14A, as indicated at V4, is reported from the first target vehicle 14A via a wireless communication channel. In a hypothesis, h_{1,4}, P1 and V4 are the same identity, while the group truth location of the first target vehicle is indicated at 14A. In other words, P1 and V4 are the same observations of 14A from two sets of sensors. Then, using sensor fusion the ground truth, G1, probability distribution can be estimated. The G1 distribution can be calculated using a second set of Bayesian Inference Model.

Referring to FIG. 4, a graph is shown illustrating the probability distributions of P1, V4 and G1, where:

$$P ( D \vert {h}_{1 , 4} ) = {G}_{1} ( {P}_{1} ) * {G}_{1} ( {V}_{4} ) ,$$

$$and$$

$$P ( D ) = {\sum }_{j , i} P ( D \vert {h}_{j , i} ) * P ( {h}_{j , i} ) .$$

In another exemplary embodiment, the system further includes a cloud-based vehicle profile database 22′, such as SIFT, SURF, BRIEF and ORB, that includes computer vision features created for each model of all vehicles. Such databases 22′ are located in the cloud 28 and are accessible via wireless communication channels 20. In an example, a target vehicle 14 transmits its model information (brand, model, year, color, etc.) to other vehicles in the vicinity using wireless communication channels 20 or cellular networks.

The data processor 16 is further adapted to use model information received from the target vehicle 14 and to receive corresponding vehicle profile data from the cloud-based vehicle profile database 22′. The ego vehicle 12 receives this model information and uses this model information to “look-up” corresponding vehicle profile data for the target vehicle 14 from the cloud-based vehicle profile database 22′. The ego vehicle 12 then has a set of physical identities from its camera-based perception sensors 24 and a set of identities and profiles received wirelessly via communication channels 20 and runs the Bayesian Inference Algorithm and calculates P(D|h_{j,i}) and P(D).

In a hypothesis, h_{1,4}, P1 (physical identity) and V4 (virtual identity) are the same identity. P1's feature can be calculated as FEATURE(P1) and V4's feature can be represented by FEATURE(V4). The feature distance can be calculated as: F_Distance(P1,V4)=|FEATURE (P1)−FEATURE(V4)|. The feature distance will follow certain probability distribution G(distance) 30, which can be created through field measurement, as illustrated in FIG. 5, where:

$$P ( D \vert {h}_{1 , 4} ) = G ( F \_ Distance ( {P}_{1} , {V}_{4} ) ,$$

$$and$$

$$P ( D ) = {\sum }_{j , i} P ( D \vert {h}_{j , i} ) * P ( {h}_{j , i} ) .$$

In an exemplary embodiment, the cloud-based vehicle profile database 22′ is a deep neural network (DNN). The DNN is adapted to learn unique signature vectors (feature vectors) for each vehicle's captured images. Signature vectors should be robust to various lighting/weather conditions, camera characteristics, viewing perspectives, etc. This is achieved with a well-balanced training dataset and effective data augmentation method.

Given a vehicle image x, a DNN defines a feature extractor F:xᵢ−Vᵢ, such that jointly with a classifier C and target class label yᵢ, C*F is trained to minimize a family of loss functions, given as:

min Σᵢ₌₁^{N}loss(C·F(x),y)+αΩ(F),

Where Ω(F) is the regularization term, and α is the weighting factor for the regularization term.

In still another exemplary embodiment, the data related to the virtual identity of the target vehicle 14 includes data collected by the perception sensors 24′ on the target vehicle 14 related to the surroundings of the target vehicle 14, including observed lane lines, surrounding vehicles, vulnerable road users (VRUs), street signs, traffic lights and structures. The data related to the virtual identity of the target vehicle 14 may also include computer vision features for the target vehicle 14 that are retrieved from a cloud-based vehicle profile database 22′.

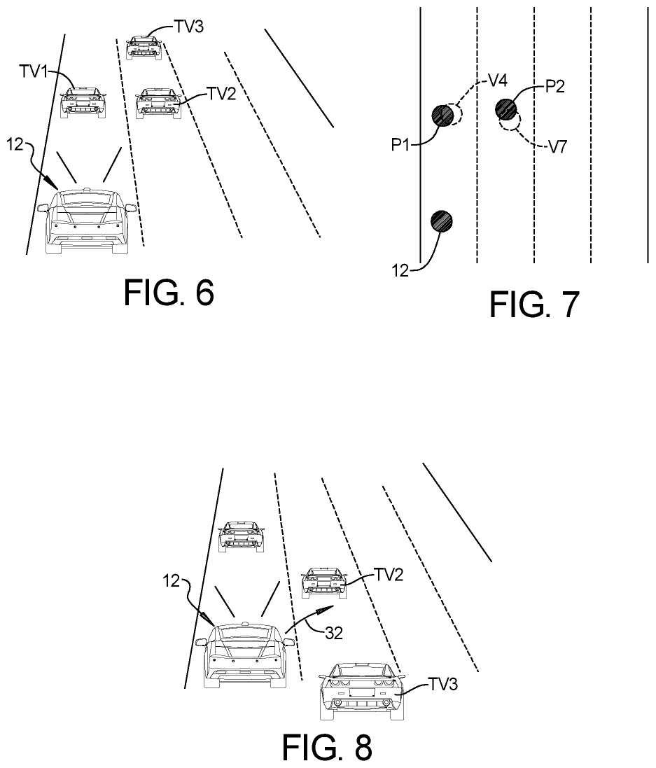

The target vehicle 14 leverages its on-board perception sensors 24′ to observe its surrounding environment. The target vehicle 14 shares its observed environment information with the ego vehicle 12 via a communication channel 20. For example, referring to FIG. 6, a target vehicle TV2 can share “one dotted lane line on the left, one dotted lane line on the right, one vehicle on the left (TV1), one vehicle in front (TV3)”. Referring to FIG. 7, the ego vehicle 12 can leverage its own on-board perception sensors 24, to observe the physical identity, P1, of target vehicle, TV1, the physical identity, P2, of target vehicle V2, and three lane lines (one solid on the left, two dotted on the right). The ego vehicle 12 matches its own observation with target vehicle TV2's shared perception data by leveraging the proposed Bayesian Inference Model.

The Bayesian Inference Model is used as follows. Referring to FIG. 7, from the perspective of the ego vehicle 12, the ego vehicle 12 observes the physical identity, P1, of the target vehicle, TV1, and receives observation data of the virtual identity, V4, of the target vehicle, TV1. The ego vehicle 12 further observes the physical identity, P2, of the target vehicle, TV2, and receives observation data of the virtual identity, V7, of the target vehicle, TV2. Finally, the ego vehicle 12 observes two dotted lane lines on the right, and one solid lane line on the left.

Virtual identity data, V7, from target vehicle, TV2, describes that it observed two dotted lane lines on the right, one target vehicle (TV1) on the left, and one target vehicle (TV3) in front. Target vehicle, TV3, is not visible, and therefore, not physically observed by the ego vehicle 12. One hypothesis is h_{2,7}−P2 and V7 are the same identity, given by:

P(D|h_{2,7})=G(P₂|h_{2,7})*G(V₇|h_{2,7}).

In reference to the lane lines:

G(P₂|h_{2,7}) is the probability of the ego car's 12 observation that there are one solid line and one dotted line in the left of a target vehicle and one dotted line on the right. As shown in FIG. 7, G(P₂|h_{2,7})=1/1=100%.

G(V₇|h_{2,7}) is the probability of a target's observation that there is one dotted line on the left of the target vehicle and one dotted line on the right of the target vehicle. As shown in FIG. 7, G(V₇|h_{2,7})=½=50%.

Therefore, P(D|h_{2,7})=100%*50%=50%. Similarly, P(D|h_{2,7}) can be calculated for other nearby vehicles.

Referring to FIG. 8, one application for a system 10 of the present disclosure is collaborative lane changing. An ego vehicle 12 wants to change to the right lane. Perception sensors on-board the ego vehicle detect that there are two target vehicles TV2, TV3 in the right lane and there isn't enough space between these two vehicles TV2, TV3 for the ego vehicle 12 to fit between them. Assuming target vehicle TV2 and target vehicle TV3 are each smart cars which can broadcast their identity information to neighboring cars via a 5G communication channel. After the ego vehicle 12 receives the virtual identity information for target vehicle TV2 and target vehicle TV3 from the communication channel, the ego vehicle 12 can utilize the proposed methods to correctly match the virtual identities of target vehicle TV2 and target vehicle TV3 to the physical identities observed by the ego vehicle 12. Then, the ego vehicle 12 can send out a “lane change” request to target vehicle TV2 asking target vehicle TV2 to speed up, and send out a request to target vehicle TV3 asking target vehicle TV3 to slow down, thus increasing the space between target vehicles TV2 and TV3 and allowing the ego vehicle 12 to safely change lanes by moving over between target vehicles TV2 and TV3, as indicated by arrow 32. Without correct physical/virtual identity matching, the ego vehicle may send out incorrect requests, for example, asking target vehicle V1 to slow down, instead of target vehicle V3.

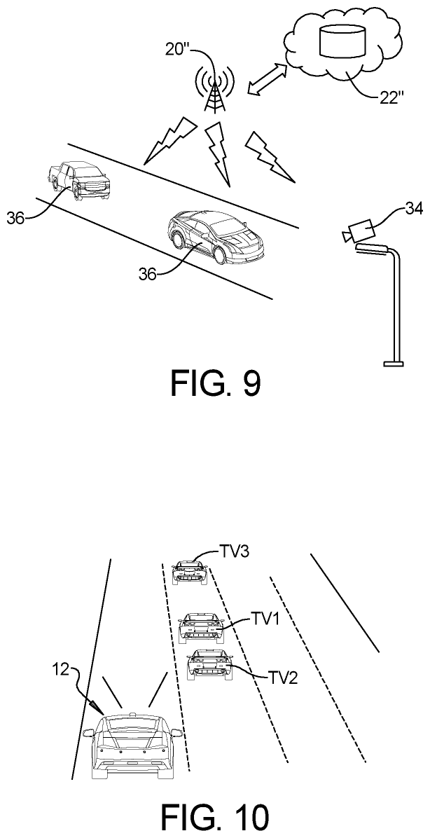

Referring to FIG. 9, another application for a system 10 of the present disclosure is for infrastructure coordinated maneuvers. In this scenario, the infrastructure is acting much like an “ego vehicle”. The infrastructure uses perception sensors, such as the camera 34 shown in FIG. 9, to detect vehicles 36 and leverages the algorithms described above to associate physical identities with virtual identities. The infrastructure communicates with a cloud-based data processor 22″ via a wireless communication network 20″ such as a WLAN, 4G/LTE or 5G network, or the like. The cloud-based data processor 22″ calculates an optimized maneuver plan for all of the vehicles 36, and sends advisory instructions to the identified vehicles 36 via the wireless communication network 20″.

For example, within the cloud-based data processor 22″, a mini database of two vehicle's profile are created, using SIFT features. When these two vehicles 36 are approaching an intersection, they share their vehicle model information (make, model, color) with the cloud-based data processor 22″ (infrastructure) via the wireless communication network 20″. The cloud-based data processor 22″ retrieves the vehicle features and finds the correct match between physical identities, i.e. images captures by infrastructure camera, and virtual identities, i.e. information shared via wireless network communication.

Additionally, the system 10 of the present disclosure may be utilized for infrastructure-assisted precise positioning. The infrastructure uses perception sensors, such as the camera 34 shown in FIG. 9, to detect vehicles 36 and leverages the algorithms described above to associate physical identities with virtual identities. Since the GPS position of the infrastructure camera 34 can be precisely determined ahead of time, the infrastructure camera 34 can indirectly infer the precise position of each of the vehicles 36 based on the camera's perception results. The infrastructure sends the inferred vehicle position to the virtual identity via wireless network communication 20″. A vehicle receiving such information can leverage this position data to help with navigation or autonomous driving in urban environments where GPS signals are blocked.

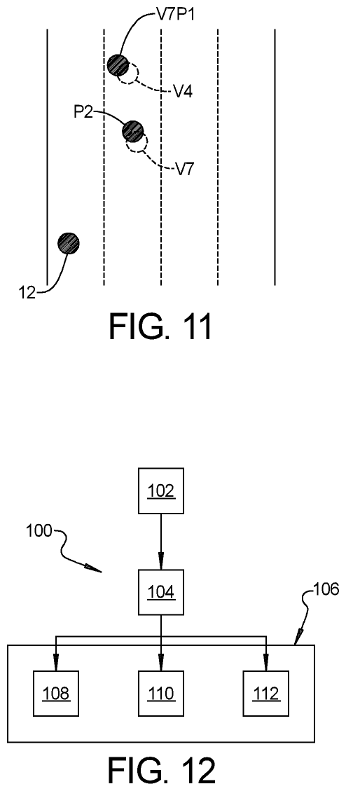

Referring to FIG. 10 and FIG. 11, another application for a system of the present disclosure is for sharing of physical/virtual identity associations. An ego vehicle 12 receives a virtual identity V4 for a first target vehicle TV1, and a virtual identity V7 for a second target vehicle TV2 via a wireless communication network. In this example, the virtual identity V4 of the first target vehicle TV1 has indicated that the first target vehicle TV1 is about to make a lane change. The virtual identity V7 of the second target vehicle TV2 indicates that the second target vehicle TV2 observed two dotted lane lines, one vehicle V7P1 in front and indicating an up-coming lane change to the left. V7P1 being the physical identity of the first target vehicle TV1 as perceived by the second target vehicle TV2 and shared virtually with the ego vehicle 12. The virtual identity V7 of the second target vehicle TV2 further confirms with onboard sensors that V7P1 is V4 (the first target vehicle TV1) and that the first target vehicle TV1 is making a lane change.

The ego vehicle 12 also observed from its' own perception sensors a physical identity P2 of the second target vehicle TV2, and three lane lines (two dotted and one solid). The physical identity of the first target vehicle TV1, and the third target vehicle TV3, are hidden from the ego vehicle 12. One hypothesis is: h2,7 P2 and V7 are the same identity (target vehicle TV2).

P(D|h_{2,7})=G(P₂|h_{2,7})*G(V₇|h_{2,7})

The ego vehicle 12 then uses the confirmation by the virtual identity V7 of the second target vehicle TV2 that V7P1 is V4 (the first target vehicle TV1), and determines that the first target vehicle TV1 is about to cut-in ahead of it and slows down. This can be extended to other scenarios where direct virtual-physical identity can not be associated (i.e. no line of sight), but can be done indirectly.

Referring to FIG. 12, a method 100 of associating a physical identity and a virtual identity of a target vehicle 14, includes, beginning at block 102, collecting, with a plurality of perception sensors 24, data related to a physical identity of the target vehicle 14 and communicating data related to the physical identity of the target vehicle 14, via a communication bus, to a data processor 16.

Moving to block 104, the method further includes, collecting, with the data processor 16, via a wireless communication channel 20, data related to a virtual identity of the target vehicle 14, and, moving to block 106, associating, with the data processor 16, the physical identity of the target vehicle 14 with the virtual identity of the target vehicle 14. In an exemplary embodiment, the associating, with the data processor 16, the physical identity of the target vehicle 14 with the virtual identity of the target vehicle 14 further includes leveraging, with the data processor, a Bayesian Interference Model and estimating, with the data processor 16, a probability that data related to the physical identity and the data related to the virtual identity are for the same target vehicle 14.

In one exemplary embodiment, moving from block 104 to block 108, the associating, with the data processor 16, the physical identity of the target vehicle 14 with the virtual identity of the target vehicle 14 further includes using the data related to the physical identity of the target vehicle 14 to determine, with the data processor 16, a relative position of the target vehicle 14, and to estimate, with the data processor 16, a real-time status of the target vehicle 14.

The data related to the physical identity of the target vehicle 14 includes global satellite positioning coordinates, speed, acceleration, yaw and heading, and the data related to the virtual identity of the target vehicle 14 includes global satellite positioning coordinates, speed, acceleration, yaw and heading.

In another exemplary embodiment, moving from block 104 to block 110, computer vision features created for each model of all vehicles are stored on a cloud-based vehicle profile database 22′, and the data related to the virtual identity of the target vehicle 14 includes model information transmitted by the target vehicle 14, the method 100 including using model information received from the target vehicle 14 and receiving, with the data processor 16, corresponding vehicle profile data from the cloud based vehicle profile database 22′. The model information transmitted by the target vehicle 14 includes, but is not limited to, brand, model, year and color. In another exemplary embodiment, the cloud-based vehicle database 22′ is a deep neural network.

In still another exemplary embodiment, moving from block 104 to block 112, the data related to the virtual identity of the target vehicle 14 includes data collected by perception sensors 24′ on the target vehicle 14 related to the surroundings of the target vehicle 14. The data related to the virtual identity of the target vehicle 14 may include, but is not limited to, observed lane lines, surrounding vehicles, vulnerable road users (VRUs), street signs, traffic lights and structures, and in some exemplary embodiments, the data related to the virtual identity of the target vehicle 14 further includes computer vision features for the target vehicle 14 that are stored on a cloud-based vehicle profile database 22′.

A system and method of the present disclosure offers several advantages. These include allowing an ego vehicle to correctly associate a physical identity of a target vehicle that is detected by perception sensors within the ego vehicle to a virtual identity of the target vehicle that is received via wireless communication between the ego vehicle and the target vehicle. This ensures that the ego vehicle knows what vehicles it may be communicating with, and that the ego vehicle knows the correct position of the target vehicles nearby. This allows the ego vehicle to properly and safely operate on roadways and highways performing such tasks as collaborative lane changing, infrastructure coordinated maneuvers, infrastructure assisted precise positioning and sharing of physical/virtual association information with nearby vehicles.

The description of the present disclosure is merely exemplary in nature and variations that do not depart from the gist of the present disclosure are intended to be within the scope of the present disclosure. Such variations are not to be regarded as a departure from the spirit and scope of the present disclosure.

What is claimed is:

1. A method of associating a physical identity and a virtual identity of a target vehicle, comprising:
collecting, with a plurality of perception sensors, data related to a physical identity of the target vehicle and communicating data related to the physical identity of the target vehicle, via a communication bus, to a data processor;
collecting, with the data processor, via a wireless communication channel, data related to a virtual identity of the target vehicle; and
associating, with the data processor, the physical identity of the target vehicle with the virtual identity of the target vehicle.

2. The method of claim 1, wherein the associating, with the data processor, the physical identity of the target vehicle with the virtual identity of the target vehicle further includes leveraging, with the data processor, a Bayesian Interference Model and estimating, with the data processor, a probability that data related to the physical identity and the data related to the virtual identity are for the same target vehicle.

3. The method of claim 2, wherein the associating, with the data processor, the physical identity of the target vehicle with the virtual identity of the target vehicle further includes using the data related to the physical identity of the target vehicle to determine, with the data processor, a relative position of the target vehicle, and to estimate, with the data processor, a real-time status of the target vehicle.

4. The method of claim 3, wherein the data related to the physical identity of the target vehicle includes global satellite positioning coordinates, speed, acceleration, yaw and heading, and the data related to the virtual identity of the target vehicle includes global satellite positioning coordinates, speed, acceleration, yaw and heading.

5. The method of claim 2, wherein computer vision features created for each model of all vehicles are stored on a cloud-based vehicle profile database, and the data related to the virtual identity of the target vehicle includes model information transmitted by the target vehicle, the method including using model information received from the target vehicle and receiving, with the data processor, corresponding vehicle profile data from the cloud based vehicle profile database.

6. The method of claim 5, wherein the model information transmitted by the target vehicle includes brand, model, year and color.

7. The method of claim 6, wherein the cloud-based vehicle profile database is a deep neural network.

8. The method of claim 2, wherein the data related to the virtual identity of the target vehicle includes data collected by perception sensors on the target vehicle related to the surroundings of the target vehicle.

9. The method of claim 8, wherein the data related to the virtual identity of the target vehicle includes observed lane lines, surrounding vehicles, vulnerable road users (VRUs), street signs, traffic lights and structures.

10. The method of claim 9, wherein the data related to the virtual identity of the target vehicle further includes computer vision features for the target vehicle that are stored on a cloud-based vehicle profile database.

11. A system for associating a physical identity and a virtual identity of a target vehicle, comprising:
a data processor, including a wireless communication module, positioned within an ego vehicle; and
a plurality of perception sensors, positioned within the ego vehicle and adapted to collect data related to a physical identity of the target vehicle and to communicate the data related to the physical identity of the target vehicle to the data processor via a communication bus;
the data processor adapted to receive, via a wireless communication channel, data related to a virtual identity of the target vehicle and to associate the physical identity of the target vehicle with the virtual identity of the target vehicle.

12. The system of claim 11, wherein, when associating the physical identity of the target vehicle with the virtual identity of the target vehicle, the data processor is further adapted to leverage a Bayesian Interference Model and estimate a probability that the data related to the physical identity and the data related to the virtual identity are for the same target vehicle.

13. The system of claim 12, wherein, when associating the physical identity of the target vehicle with the virtual identity of the target vehicle, the data processor is further adapted to use the data related to the physical identity of the target vehicle to determine a relative position of the target vehicle, and to estimate a real-time status of the target vehicle.

14. The system of claim 13, wherein the data related to the physical identity of the target vehicle includes global satellite positioning coordinates, speed, acceleration, yaw and heading, and the data related to the virtual identity of the target vehicle includes global satellite positioning coordinates, speed, acceleration, yaw and heading.

15. The system of claim 12, further including a cloud-based vehicle profile database that includes computer vision features created for each model of all vehicles, and the data related to the virtual identity of the target vehicle includes model information transmitted by the target vehicle, the data processor further adapted to use model information received from the target vehicle and to receive corresponding vehicle profile data from the cloud-based vehicle profile database.

16. The system of claim 15, wherein the model information transmitted by the target vehicle includes brand, model, year and color.

17. The method of claim 16, wherein the cloud-based vehicle profile database is a deep neural network.

18. The method of claim 12, wherein the data related to the virtual identity of the target vehicle includes data collected by perception sensors on the target vehicle related to the surroundings of the target vehicle, including observed lane lines, surrounding vehicles, vulnerable road users (VRUs), street signs, traffic lights and structures.

19. The system of claim 18, further including a cloud-based vehicle profile database that includes computer vision features created for each model of all vehicles, and the data related to the virtual identity of the target vehicle further includes computer vision features for the target vehicle.

20. A method of associating a physical identity and a virtual identity of a target vehicle, comprising:
collecting, with a plurality of perception sensors, data related to a physical identity of the target vehicle and communicating data related to the physical identity of the target vehicle, via a communication bus, to a data processor;
collecting, with the data processor, via a wireless communication channel, data related to a virtual identity of the target vehicle; and
associating, with the data processor, the physical identity of the target vehicle with the virtual identity of the target vehicle by leveraging, with the data processor, a Bayesian Interference Model and estimating, with the data processor, a probability that data related to the physical identity and the data related to the virtual identity are for the same target vehicle, and one of:
using the data related to the physical identity of the target vehicle which includes global satellite positioning coordinates, speed, acceleration, yaw and heading to determine, with the data processor, a relative position of the target vehicle, and to estimate, with the data processor, a real-time status of the target vehicle, wherein the data related to the virtual identity of the target vehicle includes global satellite positioning coordinates, speed, acceleration, yaw and heading;
using model information received from the target vehicle and receiving, with the data processor, corresponding vehicle profile data from a cloud-based vehicle profile database that is a deep neural network and includes computer vision features created for each model of all vehicles, wherein the data related to the virtual identity of the target vehicle includes model information including brand, model, year and color transmitted by the target vehicle; and
associating, with the data processor, the physical identity of the target vehicle with the virtual identity of the target vehicle wherein the data related to the virtual identity of the target vehicle includes data collected by perception sensors on the target vehicle related to the surroundings of the target vehicle including observed lane lines, surrounding vehicles, vulnerable road users (VRUs), street signs, traffic lights and structures, and computer vision features for the target vehicle that are stored on a cloud-based vehicle profile database.
